(19) United States
(12) Patent Application Publication
(10) Pub. No.: US 2024/0380301 A1
(43) Pub. Date: Nov. 14, 2024

(54) SUPERCONDUCTING ROTATING MACHINE AND SHIP, AUTOMOBILE, AIRCRAFT, AND PUMP USING SAME

(71) Applicant: KYOTO UNIVERSITY, Kyoto (JP)

(72) Inventors: Alexandre COLLE, Kyoto (JP); Taketsune NAKAMURA, Kyoto (JP)

(73) Assignee: KYOTO UNIVERSITY, Kyoto (JP)

(21) Appl. No.: 18/689,159

(22) PCT Filed: Aug. 17, 2022
(86) PCT No.: PCT/JP2022/031131

§ 371 Date: Mar. 5, 2024

(30) Foreign Application Priority Data
Sep. 10, 2021 (JP) 2021-147281

(51) Int. Cl. H02K 55/04

(52) U.S. Cl. CPC H02K 55/04

(57) ABSTRACT

A superconducting rotating machine, including: a stator that has a tubular stator iron core and a stator winding wound around the stator iron core, and that generates a rotating magnetic field, and a superconducting rotor that is rotatably held by the rotating magnetic field of the stator, and that has a superconducting winding including a plurality of coil-shaped spliceless loop members made of a superconducting material, and a rotor iron core including a slot for housing the spliceless loop members.

### TECHNICAL FIELD

The present invention relates to a superconducting rotating machine and to a ship, an automobile, an aircraft, and a pump using the superconducting rotating machine.

### BACKGROUND ART

Rotating machines, which are electrical devices, are classified into direct-current (DC) machines and alternating-current (AC) machines. Among such rotating machines, AC machines receive mechanical power and generate AC power or receive AC power and generate mechanical power, and are mainly classified into induction machines and synchronous machines.

Induction machines such as induction motors rotate by generating an induced torque on a rotor using a rotating magnetic field generated by applying a polyphase AC voltage (in many cases, a three-phase AC voltage) to a stator winding. While induction motors are widely used since they have simple structures, maintenance thereof is easy and inexpensive, and the like, there is room for improvement in terms of efficiency and speed control.

Synchronous machines such as synchronous motors rotate as a rotor including an electromagnet or a permanent magnet is attracted by a rotating magnetic field generated by applying a polyphase AC voltage (in many cases, a three-phase AC voltage) to a stator winding. While synchronous motors are highly efficient, there may be cases where an additional apparatus is required for starting and synchronizing.

In recent years, a superconducting rotating machine capable of synchronous rotation with a configuration of an induction machine has been proposed (refer to Patent Literature 1 below). For example, Patent Literature 1 discloses a method of operating a superconducting rotating machine that enables slip rotation and synchronous rotation and that is capable of automatically and stably operating the superconducting rotating machine.

### CITATION LIST

### Patent Literature

Patent Literature 1: Japanese Patent Laid-Open No. 2013

### Summary of Invention

### Technical Problem

For example, when a conventional superconducting rotating machine using a superconducting squirrel-cage winding as described above is cooled to below a critical temperature by a cooling apparatus from prior to start of operation and enters a superconducting state, the superconducting squirrel-cage winding does not trap a magnetic flux of a rotating magnetic field of a stator winding. When a three-phase AC voltage is applied to the stator winding in this state, a shielding current flows through the superconducting squirrel-cage winding and a magnetic flux interlinked with the superconducting squirrel-cage winding becomes zero (hereinafter, may also be referred to as a “magnetic shielding state”). In other words, since a magnetic flux supplied from a stator is shielded in the magnetic shielding state, a superconducting rotor does not start. Next, when an applied voltage to the stator winding is increased and/or a frequency of the applied voltage is reduced for a given period of time until a current value of a current flowing through the superconducting squirrel-cage winding (hereinafter, may also be simply referred to as a “current value (Io)”) exceeds a critical current value (Ic) and the superconducting squirrel-cage winding is changed from the magnetic shielding state to a magnetic flux flow state, since a finite resistance is generated, a magnetic flux is interlinked with the superconducting squirrel-cage winding and an induced current (magnetic flux flow current) is created, an induced torque is generated, and rotation of the superconducting rotor is induced (hereinafter, a state where the superconducting rotor is mainly caused to rotate by an induced torque may be referred to as an “slip rotation mode”).

Subsequently, a rotational motion of the superconducting rotor is accelerated, a relative speed between the rotating magnetic field and the superconducting rotor decreases and, finally, when the induced current (magnetic flux flow current) flowing through the superconducting squirrel-cage winding falls below the critical current, the superconducting squirrel-cage winding traps an interlinkage magnetic flux. When a state (hereinafter, may also be referred to as a “magnetic flux trapping state”) where the superconducting squirrel-cage winding traps the interlinkage magnetic flux is created, the superconducting rotor can synchronously rotate with respect to the rotating magnetic field (hereinafter, a state where the superconducting rotor is mainly caused to rotate by a synchronous torque may be referred to as a “synchronous rotation mode”).

Generally, a squirrel-cage winding using a superconducting material is constituted of two members, namely, a plurality of rotor bars and a pair of end rings. Each of the end rings is joined to both ends of the plurality of rotor bars and all of the rotor bars are short-circuited by the end rings. The rotor bars and the end rings are usually joined by a normal conducting alloy such as a solder.

On the other hand, when resistance of a squirrel-cage winding or the like constituted of a superconducting material is completely zero, a magnetic flux is sufficiently trapped and ideal characteristics such as those of a permanent magnet motor are realized. However, when a resistor such as a solder joint is present in the squirrel-cage winding, a current is slightly attenuated by the resistor and, consequently, the magnetic flux trapped in the synchronous operating mode attenuates. Accordingly, sufficiently establishing an exact highly-efficient synchronous rotation state is difficult.

In addition, particularly with large-sized motors, since a large current flows through a rotor winding, significant heat generation occurs when the current flows through a solder joint. While a superconducting connection technique that enables members to be joined while maintaining a superconducting state is conceivable as a method of avoiding such heat generation, superconducting connection of high-temperature superconducting materials is technically extremely difficult and success thereof is limited at present.

In order to solve the problems described above, an object of the present invention is to provide a superconducting rotating machine that is capable of highly-efficient synchronous rotation and that can be driven with low heat generation, and a ship, an automobile, an aircraft, and a pump using the superconducting rotating machine.

### Solution to Problem

The inventors of the present invention arrived at the present invention by reviewing structures of previously used superconducting squirrel-cage windings and discovering that a superconducting winding can be formed without having to use a joint by soldering.

The present invention provides a superconducting rotating machine including: a stator that has a tubular stator iron core and a stator winding wound around the stator iron core and, that generates a rotating magnetic field; and a superconducting rotor that is rotatably held by the rotating magnetic field of the stator and that has a superconducting winding including a plurality of coil-shaped spliceless loop members made of a superconducting material and a rotor iron core including a slot for housing the spliceless loop members.

As described above, using the coil-shaped spliceless loop members (hereinafter, may also be simply referred to as “loop members”) made of a superconducting material enables a superconducting winding that does not have a solder joint to be formed. Accordingly, since an attenuation of a current in the solder joint of the superconducting winding can be avoided, an attenuation of a magnetic flux being trapped in the “synchronous rotation state” can be effectively suppressed and an exact highly-efficient synchronous rotation state can be maintained. Furthermore, the superconducting winding using the coil-shaped spliceless loop members made of a superconducting material also enables heat generation in the solder joint to be avoided. Therefore, in particular, excessive heat generation that accompanies a higher output by applications such as large land transporters, ships, and aircraft can be suppressed.

As an aspect of the present invention, a superconducting rotating machine in which the superconducting winding includes a plurality of electrically separated spliceless loop members can be provided.

According to the present aspect, since there is no need to short-circuit each spliceless loop member, a superconducting winding can be constructed without having to use a member that corresponds to an end ring of a squirrel-cage winding.

As an aspect of the present invention, a superconducting rotating machine in which the spliceless loop members are sheet-like members having a notched part can be provided.

According to the present aspect, using a sheet-like member having a notched part enables a spliceless loop member with a simple structure to be provided.

As an aspect of the present invention, a superconducting rotating machine in which the spliceless loop member is housed in the slot so as come into contact with at least a part of another one of the spliceless loop members can be provided.

According to the present aspect, housing the spliceless loop members in the slot so that the spliceless loop members come into contact with each other promotes thermal conduction between the spliceless loop members and enables a further heat generation suppression effect to be exerted.

Furthermore, as an aspect of the present invention, a ship, an automobile, an aircraft, or a pump using the superconducting rotating machine described above is provided. According to the present aspect, using the superconducting rotating machine described above enables a ship, an automobile, an aircraft, or a pump with superior energy efficiency to be manufactured.

### Advantageous Effects of Invention

According to the present invention, a superconducting rotating machine that is capable of highly-efficient synchronous rotation and that can be driven with low heat generation, and a ship, an automobile, an aircraft, and a pump using the superconducting rotating machine can be provided.

### BRIEF DESCRIPTION OF DRAWINGS

FIG. 1 is a schematic diagram for describing a magnetic shielding state, a magnetic flux flow state, and a magnetic flux trapping state.

FIG. 2 is a schematic diagram showing an example of a motor body of a superconducting rotating machine.

FIG. 3 is an explanatory diagram showing a relationship between a stator and a superconducting rotor.

FIG. 4 is an explanatory diagram showing an example of the configuration of a superconducting rotor.

FIG. 5 is a schematic diagram showing an aspect of a spliceless loop member.

FIG. 6 is a graph showing a change over time of an electromagnetic torque upon start-up in a comparison between a superconducting rotating machine according to an embodiment and a conventional structure HTS-ISM.

FIG. 7 is an explanatory diagram showing another example of the configuration of a superconducting rotor.

### DESCRIPTION OF EMBODIMENT

Hereinafter, a superconducting rotating machine according to the present embodiment will be described using drawings when appropriate. However, it is to be understood that the present invention is not limited to the following embodiment. In addition, same or equivalent members in the following description will be denoted by a same reference sign and a description thereof may be omitted. Note that in the present specification, an AC voltage applied to the superconducting rotating machine is a polyphase AC voltage (for example, a three-phase AC voltage) except as otherwise limited, and a voltage applied to the superconducting rotating machine refers to a “line voltage” except as otherwise limited.

As described above, the superconducting rotating machine according to the present embodiment is a rotating machine that includes a superconducting rotor and that is capable of being mainly driven by a synchronous torque despite being an induction motor by driving a superconducting winding including a plurality of coil-shaped spliceless loop members made of a superconducting material in a superconducting state. The superconducting rotating machine according to the present embodiment can be mainly driven by a synchronous torque due to the superconducting rotor changing from a magnetic shielding state to a magnetic flux trapping state via a magnetic flux flow state.

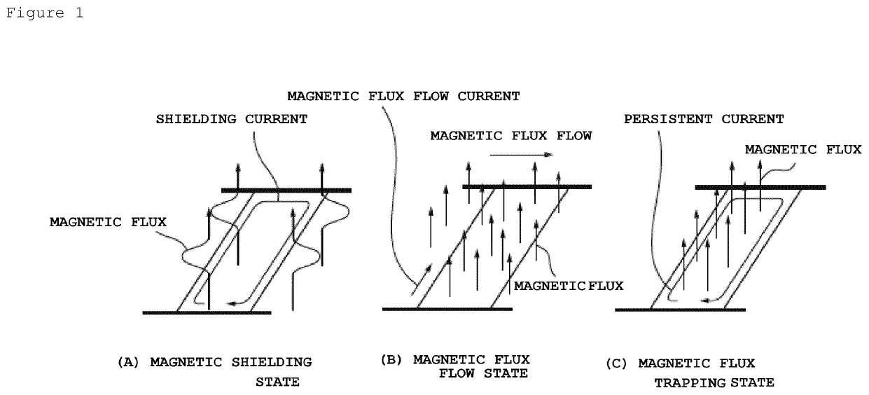

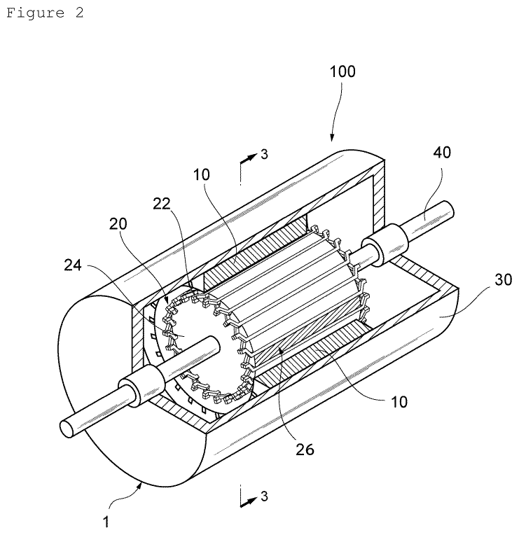

First, the magnetic shielding state, the magnetic flux flow state, and the magnetic flux trapping state according to the present embodiment will be described with reference to the drawings. FIG. 1 is a schematic diagram for describing the magnetic shielding state, the magnetic flux flow state, and the magnetic flux trapping state. FIG. 1 shows an electromagnetic phenomenon in a loop of a superconducting winding (a loop of a coil-shaped spliceless loop member 26 in FIG. 2 to be described later). In this case, a “spliceless loop member” refers to a coil-shaped member that is continuously formed without a joint or a coupling due to soldering or the like and that has a loop.

When driving the superconducting rotating machine according to the present embodiment, cooling the superconducting winding in a stationary state to below a critical temperature by a cooling apparatus creates a state where the superconducting winding is not capturing a magnetic flux due to a stator winding while being superconductive. When a three-phase AC voltage is applied to the stator winding in this state, a shielding current flows through the superconducting winding and the superconducting winding enters the magnetic shielding state. In the magnetic shielding state, a current value (Io) of the shielding current that flows through the superconducting winding and a critical current value (Ic) is expressed as Io<Ic and a magnetic flux that is interlinked with the superconducting winding becomes zero (refer to FIG. 1(A)). In this case, since a synchronous torque is not generated and an induced current does not flow, an induced (sliding) torque is similarly not generated.

Next, in order to drive the superconducting rotating machine according to the present embodiment, first, the superconducting winding is caused to transition from the magnetic shielding state to the magnetic flux flow state. In order to cause the superconducting winding to transition to the magnetic flux flow state, the magnetic shielding state due to the shielding current must be cancelled by setting the current value (Io) of the current flowing through the superconducting winding higher than the critical current value (Ic) (Io>Ic). Once the superconducting winding transitions to the magnetic flux flow state, a magnetic flux of the rotating magnetic field can interlink with the superconducting winding and an induced current (magnetic flux flow current) flows through the superconducting winding (refer to FIG. 1(B)). Accordingly, a finite resistance is generated between the rotating magnetic field and the superconducting rotor and rotation of the superconducting rotor is induced (slip rotation mode).

Subsequently, the superconducting rotor is accelerated, a relative speed between the rotating magnetic field and the superconducting rotor decreases with the acceleration, and the current flowing through the superconducting rotor automatically decreases. Finally, when the current value (Io) of the current flowing through the superconducting rotor drops below the critical current value (Ic), the superconducting rotor traps the interlinkage magnetic flux and the superconducting winding transitions from the magnetic flux flow state to the magnetic flux trapping state (refer to FIG. 1(C)). In the magnetic flux trapping state, due to the superconducting rotor capturing the magnetic flux of the rotating magnetic field, the superconducting rotor can be mainly caused to rotate by a synchronous torque (synchronous rotation mode).

Since the superconducting winding according to the present embodiment is constructed using a plurality of coil-shaped spliceless loop members in which the superconducting winding is made of a superconducting material, there is no attenuation of a current at a solder joint and no attenuation of a trapped magnetic flux attributable to such an attenuation of a current. Therefore, the superconducting rotating machine according to the present embodiment can sufficiently maintain a highly-efficient synchronous rotation mode. Furthermore, since there is no heat generation at a solder joint, the superconducting rotating machine according to the present embodiment can be driven with low heat generation even when, for example, a size of the apparatus is increased. A structure of the coil-shaped spliceless loop member will be described later.

### <<Superconducting Rotating Machine>>

### <Motor Body>

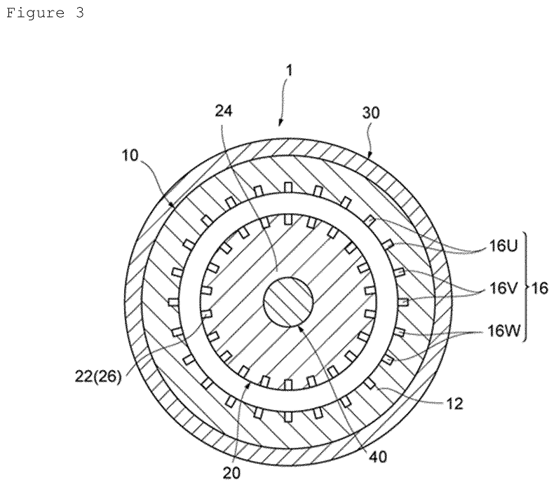

A preferable aspect of a motor body according to the present embodiment will be described with reference to the drawings. FIG. 2 is a schematic diagram showing an example of the motor body of a superconducting rotating machine 100 according to the present embodiment. FIG. 3 is a sectional view taken along 3-3 of a motor body 1 in FIG. 2 and is an explanatory diagram showing a relationship between a stator and a superconducting rotor. As shown in FIG. 2, the superconducting rotating machine 100 includes the motor body 1, and the motor body 1 includes a stator 10 that generates a rotating magnetic field and a superconducting rotor 20 that is rotatably held on an inner circumferential side of the stator 10. In addition, the stator 10 and the superconducting rotor 20 are stored in a cylindrical case 30. As will be described below, in the superconducting rotating machine 100 according to the present embodiment, the superconducting rotor 20 rotates around a rotary shaft 40 when a three-phase current is passed through the stator 10.

### (Stator)

As shown in FIGS. 2 and 3, the stator 10 has a tubular stator iron core 12 and stator windings 160, 16V, and 16W (hereinafter, may also be collectively simply referred to as a “stator winding 16”) that are wound around the stator iron core 12 and that are made of a superconducting wire rod. A rotating magnetic field is generated by passing a three-phase current through the stator winding 16. However, the stator 10 according to the present embodiment is not limited to a stator having a stator winding made of a superconducting wire rod and may be a stator having a stator winding made of a normal conducting wire rod as in the case of a modification to be described later.

The stator iron core 12 is a member with a tubular shape and of which a cross section in a radial direction has an annular shape. In addition, a member in which an electromagnetic steel plate such as a silicon steel plate is laminated in an axial direction can be used as the stator iron core 12. Furthermore, the stator iron core 12 is provided with slots (not illustrated) along a circumference at equal intervals in an axial direction of a shaft and the stator winding 16 is housed in the slots. While the stator iron core 12 is fastened to an inner wall of the case 30 of the motor body 1, alternatively, the stator iron core may be fastened to the inner wall of the case 30 via a joint. While a stator having slots is used in the present embodiment, the present invention is not limited to this aspect and a stator provided with an open slot or a groove instead of slots can also be used.

The stator winding 16 is made by bundling a plurality of superconducting wire rods (in the present embodiment, yttrium-based high-temperature superconducting wire rods) and each wire rod has (but not limited to) a rectangular cross sectional shape. The superconducting wire rods are constructed by coating a plurality of yttrium-based high-temperature superconducting filaments with a highly conductive metal such as copper, aluminum, silver, or gold. Note that from the perspective of easiness at start-up of the superconducting rotating machine 100, preferably, a superconducting wire rod with a higher critical temperature than a critical temperature of the superconducting wire rod used in a superconducting winding 22 is used as the superconducting wire rod used in the stator winding 16 of the stator 10.

As described above, the stator winding 16 is inserted into the slots on a surface of the stator iron core 12 and functions as a coil. In the present embodiment, 24 slots are provided so as to be arranged at equal intervals in a circumferential direction on a side of an inner circumferential surface of the stator iron core 12. In addition, as shown in FIG. 3, the stator winding 16 is arranged (wound) clockwise in the circumferential direction of the stator iron core 12 so that rotating magnetic fields are created in an order of the stator windings 160, 16V, and 16W.

In the present embodiment, the stator windings 16 are three-phase windings and each stator winding 16 is wire-connected. The superconducting rotating machine 100 is a three-phase motor and each stator winding 16 is assigned to any of a U-phase coil, a V-phase coil, and a W-phase coil. In other words, 24 superconducting coils are to be arranged on the stator iron core 12. More specifically, eight U-phase superconducting coils (stator windings 16U), eight V-phase superconducting coils (stator windings 16V), and eight W-phase superconducting coils (stator windings 16W) are to be arranged on the stator iron core 12. Each of the eight U-phase superconducting coils is electrically connected in series, each of the eight V-phase superconducting coils is electrically connected in series, and each of the eight W-phase superconducting coils is electrically connected in series. Note that a connection method of each stator winding 16 may be a series connection or a parallel connection.

A method of wire connection of each stator winding 16 is not particularly limited and a star connection, a delta connection, or the like may be used. In addition, a method of winding the stator winding 16 around the stator iron core 12 may be concentrated winding or distributed winding. In the present embodiment, a rotating magnetic field of which the number of poles is four is formed in the stator iron core 12 by passing a three-phase current through the stator winding 16. In the present embodiment, the number of turns per pole and per phase of the stator winding 16 is 12. As winding directions of the respective stator windings, the winding directions of the stator winding 16U and the stator winding 16W are the same but the winding direction of the stator winding 16V is opposite to the winding directions of the stator winding 16U and the stator winding 16W.

A drive circuit that applies a drive voltage to the stator winding 16 is electrically coupled to the stator 10.

### (Superconducting Rotor)

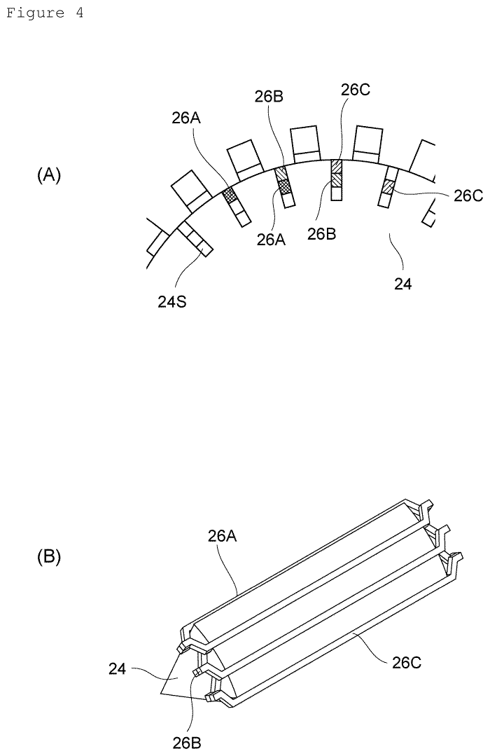

As shown in FIGS. 2 and 3, the superconducting rotating machine 100 according to the present embodiment includes the superconducting rotor 20 that is rotatably held on an inner circumferential side of the stator 10. In addition, as shown in FIGS. 3 and 4, the superconducting rotor 20 includes the superconducting winding 22 and a rotor iron core 24. FIG. 4 is an explanatory diagram showing an example of the configuration of the superconducting rotor. More specifically, FIG. 4(A) is a schematic diagram showing a cross-sectional structure of the rotor in which a spliceless loop member is housed and FIG. 4(B) is a perspective view showing a state where a spliceless loop member is arranged on a surface of the rotor iron core.

As shown in FIG. 3, the superconducting rotor 20 is arranged at predetermined intervals on an inner circumferential side of the stator 10. Next, as shown in FIG. 3, the rotor iron core 24 of the superconducting rotor 20 has a cylindrical shape and includes a plurality of slots for housing the respective spliceless loop members on an outer circumferential surface side thereof. Furthermore, the superconducting rotor 20 includes the rotary shaft 40 that is coaxially mounted to the rotor iron core 24. In addition, the superconducting rotor 20 includes the superconducting winding 22 having a spliceless loop member 26 that is made of a superconducting material. Note that as shown in FIG. 4, the slots may be an open slot or may have a groove shape in the present embodiment.

The rotor iron core 24 can be formed by laminating an electromagnetic steel plate such as a silicon steel plate in an axial direction. Although not illustrated, a rotary shaft receiving hole for receiving the rotary shaft 40 is formed in a central part of the rotor iron core 24. In addition, a plurality of slots 24S provided in an axial direction are formed at predetermined intervals in a circumferential direction in a vicinity of an outer circumference of the rotor iron core 24. While the slots 24S are formed so as to be parallel with respect to the axial direction of the rotor iron core 24 (an angle formed between the axial direction of the rotor iron core 24 and the slots 24S is 0 degrees) in the present embodiment, the present invention is not limited to this aspect.

The superconducting winding 22 is constituted of a plurality of spliceless loop members including spliceless loop members 26A to 26C. The plurality of spliceless loop members 26 are housed in the slots 24S of the rotor iron core 24.

The spliceless loop members 26 are loop-shaped spliceless (joint-less) members made using a superconducting material (an yttrium-based high-temperature superconducting material in the present embodiment) with a sheet shape and having a notched part. A type of the superconducting material is not particularly limited and a bismuth-based high-temperature superconducting material or other superconducting materials may be used. In addition, the spliceless loop members 26 may be constructed by being coated with a highly conductive metal such as copper, aluminum, silver, or gold.

As shown in FIGS. 4(A) and 4(B), in the present embodiment, one spliceless loop member 26 is arranged such that a pair of long side parts (portions extending in the axial direction) are housed in each of the slots 24S that are adjacent to each other. In the present embodiment, the number of the slots 24S and the number of the spliceless loop members of the rotor iron core 24 are both 22. From the perspective of optimizing a start-up condition, the number of coils of the stator (the number of stator slots) and the number of slots of the rotor preferably differ from each other.

In addition, in the present embodiment, the spliceless loop members 26 are arranged so that adjacent spliceless loop members 26 at least partially come into contact with each other. For example, as shown in FIGS. 4(A) and 4(B), one long side part of the spliceless loop member 26B is in contact with a long side part of the spliceless loop member 26A and the other long side part of the spliceless loop member 26B is in contact with a long side part of the spliceless loop member 26C. Each spliceless loop member 26 is arranged so that long side parts overlap with each other in a radial direction of the rotor iron core 24 (a depth direction of the slots 24S). However, since the loop of each spliceless loop member 26 becomes a main current route, the respective spliceless loop members 26 are electrically separated from each other. In other words, while the loop of the spliceless loop member 26A constitutes a loop structure itself in the spliceless loop member 26A, since a resistance value (R^{s}) of a surface of the spliceless loop member 26A in contact with another member (another spliceless loop member 26) is sufficiently larger than an electrical resistance (Rⁱⁿ) created by the loop structure of the spliceless loop member 26A, a short-circuit does not occur between the spliceless loop member 26A and another spliceless loop member that comes into contact with the spliceless loop member 26A and the respective spliceless loop members 26 are substantially electrically separated from one another. Therefore, each spliceless loop member 26 is not short-circuited despite each spliceless loop member 26 being in partial contact with another spliceless loop member. In this manner, since there is no need to short-circuit the spliceless loop members 26, a superconducting winding can be readily constructed without having to use a member that corresponds to an end ring of a squirrel-cage winding. On the other hand, the spliceless loop members 26 are capable of thermal conduction despite being electrically separated from each other. Therefore, a more superior heat generation suppression effect can be exerted by thermal diffusion between the respective spliceless loop members 26.

In addition, in the present embodiment, the spliceless loop members are sequentially arranged so that a long side of one adjacent spliceless loop member is positioned on an upper side in the depth direction of another spliceless loop member (an outer side in the radial direction of the rotor iron core 24). For example, in FIG. 4(B), in a relationship between spliceless loop members positioned on a left side of a paper plane or, in other words, the spliceless loop members 26A and 26B, the spliceless loop members 26A and 26B are arranged so that a long side of the spliceless loop member 26A is positioned on an upper side in the depth direction of the spliceless loop member 26B. In a similar manner, in a relationship between the spliceless loop members 26B and 26C, the spliceless loop members 26B and 26C are arranged so that a long side of the spliceless loop member 26B is positioned on an upper side in the depth direction of the spliceless loop member 26C.

The spliceless loop members 26 are formed so as to be longer than a length in the axial direction of the rotor iron core 24 and, when housed in the slots 24S, both distal ends of the spliceless loop members 26 protrude from the slots 24S.

While a case of using the superconducting rotor 20 in which only the superconducting winding 22 is installed on the rotor iron core 24 has been described in the present embodiment, alternatively, the superconducting rotating machine 100 may be configured so as to have a normal conducting winding in addition to the superconducting winding. Examples of a normal conducting material used in the normal conducting winding include a highly conductive material such as copper, aluminum, silver, or gold. The normal conducting winding may be a conventional squirrel-cage winding or a member with a spliceless loop shape.

The rotary shaft 40 is mounted by being inserted into the rotary shaft receiving hole of the rotor iron core 24. The rotary shaft 40 is rotatably supported inside the case 30 via a shaft bearing such as bearings (not illustrated).

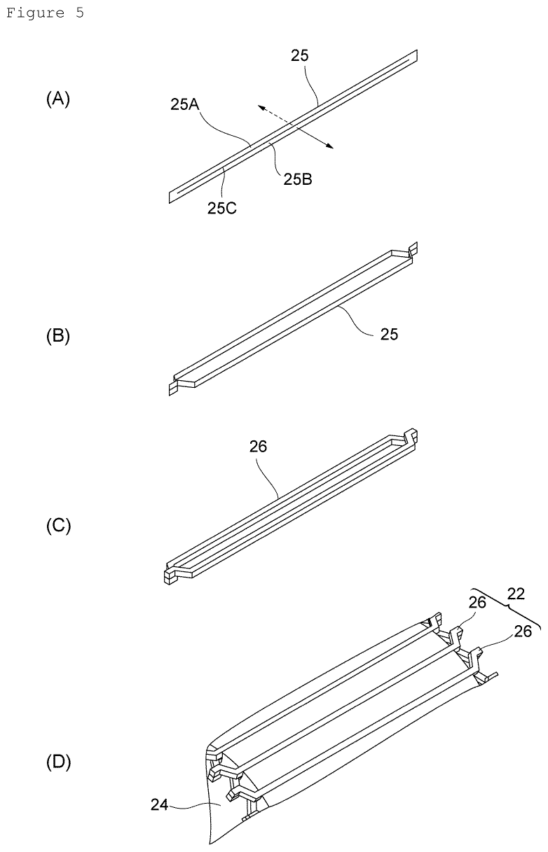

Next, a structure of the spliceless loop member 26 according to the present embodiment will be described. FIG. 5 is a schematic diagram showing an aspect of the spliceless loop member. A formation method of the spliceless loop member 26 will be described with reference to FIG. 5. As shown in FIG. 5(A), the spliceless loop member 26 is formed using a sheet-like member 25 of an yttrium-based high-temperature superconducting material with a thin sheet shape. A general high-temperature superconducting wire rod has a thin sheet shape with a large aspect ratio and the tape is cut at a predetermined length to form the sheet-like member 25. Next, as shown in FIG. 5(A), a notched part 25C is formed in a length direction (long side direction) at approximately center in the width direction (short side direction) of the sheet-like member 25. The notched part 25C is formed so that both distal ends thereof are positioned slightly inside in the length direction from both distal ends of the sheet-like member 25. A length of the notched part 25C is set as follows. For example, from the perspective of securing a superconducting current path, in a region that is positioned at each end of the sheet-like member 25 and that does not have a notch (hereinafter, simply referred to as an “end part of the sheet-like member 25”), it is required that a distance from the distal end of the notched part 25C to the distal end of the sheet-like member 25(a distal end in the long side direction) (hereinafter, simply referred to as a “width of an end part of the sheet-like member 25”) is equal to or longer than a width of an upper part 25A and a lower part 25B (a width in the short side direction) in FIG. 5(A). Furthermore, a bending strain of the end part of the sheet-like member 25 increases in accordance with a size of a loop structure that is formed using the sheet-like member 25. Therefore, the width of the end part of the sheet-like member 25 is preferably large enough to allow an increase in the bending strain in accordance with the size of the loop structure. For this reason, the length of the notched part 25C is set so that the width of the end part of each sheet-like member 25 becomes wider than the width of the upper part 25A and the like so as to allow an increase in the bending strain.

Next, in accordance with directions of an arrow depicted by a solid line and an arrow depicted by a dashed line that represent mutually opposite directions in FIG. 5(A), the upper part 25A and the lower part 25B of the sheet-like member are respectively widened in opposite directions and the sheet-like member 25 is made into a loop shape as shown in FIG. 5(B). Accordingly, a spliceless loop without a joint is formed. While a shape of the spliceless loop member is an approximately hexagonal shape in FIGS. 5(B) to 5(C) and the like, the present invention is not limited to a hexagonal shape and enables a desired shape such as a circular shape (elliptical shape) or a polygonal shape other than a hexagonal shape (such as a quadrilateral shape or a pentagonal shape) to be adopted.

One spliceless loop member 26 is made into a conductor by laminating (stacking) a plurality of the sheet-like members 25. Specifically, in accordance with FIGS. 5(A) and 5(B), a plurality of the sheet-like members 25 having been given a loop shape are fabricated and the plurality of the sheet-like members 25 having been given a loop shape are stacked to form the spliceless loop member 26 (refer to FIG. 5(C)). While the number of stacks of the sheet-like members 25 also fluctuate depending on a size and/or a thickness, the number of stacks is determined in accordance with a desired current value of the spliceless loop member 26.

A fabrication method of the spliceless loop member 26 is not limited to the method described above and, for example, the spliceless loop member 26 may be made by stacking the sheet-like members 25 and subsequently widening the upper part 25A and the lower part 25B of the stacked sheet-like members 25 in respectively opposite directions. In addition, the sheet-like members 25 may be stacked either before or after the formation of the notched part 25C. When the sheet-like members 25 are stacked before forming the notched part 25C, the notched part 25C can be collectively formed in the plurality of sheet-like members 25 after stacking.

As described above, by arranged the plurality of obtained spliceless loop members 26 in accordance with a desired pattern in slots on the rotor iron core 24, the superconducting winding 22 that is constituted of the plurality of spliceless loop members 26 and that does not have a solder joint and the like can be formed (refer to FIG. 5(D)).

### [Drive Method of Superconducting Rotating Machine]

For example, in addition to ships, automobiles (small automobiles, midsize automobiles, and large automobiles such as buses and trucks), aircraft, and pumps (for example, a liquid circulation and transfer pump), the superconducting rotating machine 100 configured as described above can be widely installed in heavy machinery, on railroads, in mobile objects including submarines, at various locations such as wind power generation and inside installations, and the like and can be applied to a superconducting motor system described in International Publication No. WO 2009/116219 and the like.

For example, the superconducting rotating machine 100 can be applied to a system including driven means such as a wheel, a propeller, or a screw that rotates when coupled to a rotating machine. For example, the system is configured so as to include: the superconducting rotating machine 100; driven means such as a wheel that is directly coupled or coupled via another member to the superconducting rotating machine 100; a cooling apparatus capable of cooling the superconducting rotating machine 100 to a superconducting state; a control apparatus that controls the cooling apparatus in accordance with a cooling signal and that controls the superconducting rotating machine 100 via an inverter in accordance with a motor drive signal; and a battery for driving the superconducting rotating machine 100.

While the cooling apparatus is not particularly limited as long as the cooling apparatus is capable of cooling the stator 10 and the superconducting winding 22 that use superconductivity inside the superconducting rotating machine 100 to a superconducting state (under a critical temperature), for example, a cooling apparatus that uses helium gas, liquid nitrogen, or the like as a refrigerant can be used.

The control apparatus is not particularly limited as long as the control apparatus is capable of controlling drive of the superconducting rotating machine 100 via a power supply apparatus such as an inverter. For example, the control apparatus controls an amplitude and a frequency of an AC voltage that is applied to the stator winding 16 of the superconducting rotating machine 100 via a power supply apparatus such as an inverter. Accordingly, the control apparatus can perform feedback control of the number of revolutions and a torque of the superconducting rotating machine 100. In addition, preferably, a control pattern for sliding rotation (first control pattern) that is used when the superconducting rotating machine 100 is mainly caused to rotate by an induced (sliding) torque and a control pattern for synchronous rotation (second control pattern) that is used when the superconducting rotating machine 100 is mainly caused to rotate by a synchronous torque are stored in the control apparatus in advance. In this case, as the control pattern for sliding rotation, a known control pattern that is used with respect to conventional induction motors can be adopted. In a similar manner, as the control pattern for synchronous rotation, a known control pattern that is used with respect to conventional synchronous motors can be adopted.

In addition, the control apparatus can be configured to determine whether or not the spliceless loop members 26 of the superconducting winding 22 are in a superconducting state, or determine whether or not the superconducting rotating machine 100 is mainly caused to rotate by a synchronous torque by monitoring a primary current signal, which is a signal of a primary current flowing through the stator winding 16 from the superconducting rotating machine 100, or the like. For example, a configuration can be adopted in which when the rotor is mainly caused to rotate by a synchronous torque, the control pattern for synchronous rotation is applied to the superconducting rotating machine 100, but otherwise the control pattern for sliding rotation is applied on the assumption that the rotor is mainly caused to rotate by an induced (sliding) torque.

Furthermore, the control apparatus can be configured to increase an applied voltage and/or reduce a frequency of the applied voltage to the stator winding 16 so as to place the superconducting winding 22 in a magnetic flux flow state when the superconducting winding 22 is in a superconducting state while not capturing a magnetic flux of the rotating magnetic field created by the stator winding 16. By temporarily entering the magnetic flux flow state, the superconducting winding 22 (the spliceless loop members 26) can trap an interlinkage magnetic flux even in a state under the critical temperature.

For example, when the superconducting winding 22 has been cooled by a cooling apparatus to below the critical temperature from prior to the start of operation, the superconducting winding 22 should be in a superconducting state while not capturing a magnetic flux created by the stator winding 16. When an AC voltage is applied to the stator winding 16 in this state, a shielding current flows through the superconducting winding 22 and magnetic fluxes interlinked with the superconducting winding 22 and normal conducting squirrel-cage windings 22B and 32B become zero (refer to FIG. 1(A)). In this case, since a synchronous torque is not generated, the superconducting rotating machine 100 cannot operate in this state.

In consideration thereof, using the control apparatus, the applied voltage to the stator winding 16 is increased and/or the frequency of the applied voltage to the stator winding 16 is reduced so as to place the superconducting winding 22 in the magnetic flux flow state until the shielding current flowing through the superconducting winding 22 exceeds the critical current. Since a finite resistance is generated in the magnetic flux flow state, a magnetic flux can be interlinked with the superconducting winding 22 (the spliceless loop members 26) even in a state below the critical temperature (refer to FIG. 1(B)).

Subsequently, the superconducting rotor 20 is accelerated and, if a relative speed between the rotating magnetic field and the superconducting rotor 20 decreases with the acceleration, the current flowing through the superconducting winding 22 automatically decreases. Finally, when the current flowing through the superconducting winding 22 drops below the critical current, the superconducting winding 22 traps the interlinkage magnetic flux (refer to FIG. 1(C)).

Hereinafter, an example of a drive method of a system using the superconducting rotating machine 100 will be described. However, it is to be understood that the present invention is not limited to the following aspect. First, the stator winding 16 is cooled to below a critical temperature of a superconducting wire rod that is used in the winding by a cooling apparatus in order to place the stator 10 in a superconducting state. In doing so, the cooling temperature is set to a temperature that is equal to or lower than the critical temperature of the superconducting wire rod used in the stator winding 16 of the stator 10 but higher than the critical temperature of the superconducting wire rod material used in the spliceless loop members 26, and the superconducting rotating machine 100 is started in a state where the superconducting winding 22 is in a normal conducting state.

Once the superconducting winding 22 drops below the critical temperature and transitions to a superconducting state after a predetermined time period elapses, the control apparatus increases an applied voltage and/or reduces a frequency of the applied voltage to the stator winding 16 so as to place the superconducting winding 22 in a magnetic flux flow state until the shielding current flowing through the superconducting winding 22 exceeds the critical current. As described earlier, in the magnetic flux flow state, a magnetic flux can be interlinked with each superconducting winding even in a state below the critical temperature.

Subsequently, the superconducting rotor 20 is accelerated and, if a relative speed between the rotating magnetic field and the superconducting rotor 20 decreases with the acceleration, the current flowing through the superconducting winding 22 (the spliceless loop members 26) automatically decreases. Finally, when the current flowing through the superconducting winding 22 drops below the critical current, the superconducting winding 22 traps the interlinkage magnetic flux. In addition, the superconducting rotating machine 100 is mainly caused to rotate by a synchronous torque. Furthermore, the control apparatus applies the control pattern for synchronous rotation to the superconducting rotating machine 100 being mainly caused to rotate by a synchronous torque and controls drive of the superconducting rotating machine 100. In other words, in the superconducting state, the superconducting rotating machine 100 exerts torque characteristics corresponding to synchronous rotation (superconducting state).

### Advantageous Effects

According to the superconducting rotating machine 100 configured as described above, since the superconducting winding 22 is constructed using a plurality of the coil-shaped spliceless loop members 26 that are made of a superconducting material, there is no attenuation of a current at a solder joint and no attenuation of a trapped magnetic flux attributable to such an attenuation of a current. Therefore, the superconducting rotating machine according to the present embodiment can sufficiently maintain a highly-efficient synchronous rotation mode. Furthermore, since there is no heat generation at a solder joint, the superconducting rotating machine according to the present embodiment can be driven with low heat generation even when, for example, a size of the apparatus is increased.

In addition, the superconducting winding 22 includes the plurality of electrically separated spliceless loop members. In the superconducting rotating machine 100, since there is no need to short-circuit the spliceless loop members 26, a superconducting winding can be readily constructed without having to use a member that corresponds to an end ring of a squirrel-cage winding. As described above, the fact that the superconducting rotating machine 100 can be driven without having to use a member that corresponds to an end ring in the rotor is a new finding made in the present invention.

Furthermore, forming the spliceless loop members 26 using a sheet-like member having a notched part enables the spliceless loop members to be readily formed.

According to the present aspect, since each spliceless loop member 26 is housed in the slot 24S so as to come into contact with at least a part of another spliceless loop member and heat is conducted between the spliceless loop members, a further heat generation suppression effect can be exerted.

For example, it was confirmed that the superconducting rotating machine according to the embodiment described above can be driven in the synchronous rotation mode under the following conditions.

### (Conditions)

Outer diameter of rotor: 302 mm (core: electromagnetic steel plate, spliceless loop members: superconducting wire (yttrium-based high-temperature superconducting wire rod))
Inner diameter of stator: 160 mm (core: electromagnetic steel plate, windings: superconducting wire (yttrium-based high-temperature superconducting wire rod))
Shaft length: 100.0 mm
Number of poles: 4
Number of stator slots: 24
Number of spliceless loop members: 22
Arrangement pattern of spliceless loop members: pattern shown in FIG. 4 (CASE 1)

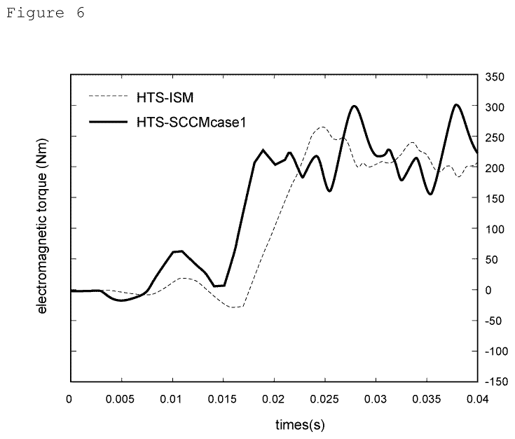

FIG. 6 shows a change over time of an electromagnetic torque upon start-up in a comparison with a conventional structure (HTS-ISM). As shown in FIG. 6, it is revealed that the superconducting rotating machine according to the present embodiment realizes a torque comparable to that of a superconducting rotating machine (HTS-ISM) using a conventional squirrel-cage rotor winding and the superconducting rotating machine is appropriately driven in the configuration according to the present embodiment. In FIG. 6, while an average torque after reaching a steady state was 209 N·m in the case of the superconducting rotating machine (HTS-ISM) using a conventional squirrel-cage rotor winding, the superconducting rotating machine according to the present embodiment demonstrated a similar average torque, 220 N·m.

### [Modifications]

While the present embodiment has been described above in specific terms, the present embodiment can be implemented by modifying the present embodiment as follows.

### (First Modification)

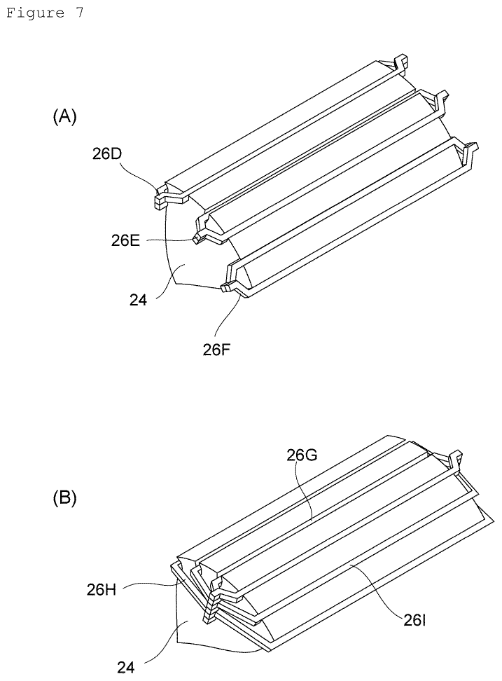

For example, while the arrangement pattern described in FIG. 4 has been adopted as the arrangement pattern of the spliceless loop members 26 in the example described above, the present invention is not limited to this aspect. For example, an arrangement pattern such as that shown in FIGS. 7(A) and 7(B) may be adopted as the arrangement pattern of the spliceless loop members 26. FIG. 7 is a schematic diagram showing another aspect of the spliceless loop members. As the arrangement pattern of the spliceless loop members, for example, as shown in FIG. 7(A), the respective spliceless loop members may be arranged in a circumferential direction of the rotor iron core 24 so as not to overlap with each other as in the case of spliceless loop members 26D to 26F or, as shown in FIG. 7(B), a structure may be adopted in which a multi-loop structure is created by coupling a plurality of spliceless loop members (spliceless loop members 26G to 26I) to form a single member and spliceless loop members with such a multi-loop structure are arranged in plurality in the circumferential direction of the rotor iron core 24.

In addition, while an aspect of using the plurality of spliceless loop members 26 as separate members has been described in the example presented above, the present invention is not limited to this aspect. For example, in the superconducting rotating machine 100, a plurality of spliceless loop members may be integrally formed to create a single spliceless loop member with a multi-loop structure and the superconducting winding 22 may be constituted of the single spliceless loop member with a multi-loop structure.

### (Second Modification)

For example, while an aspect in which the superconducting rotor 20 only has the superconducting winding 22 constituted of spliceless loop members 26 as rotor windings has been described in the example presented above, the present invention is not limited to this aspect. For example, an aspect of the superconducting rotating machine 100 may be adopted in which the superconducting rotor 20 further includes a single or a plurality of normal conducting squirrel-cage windings that are made of a normal conducting material in addition to the superconducting winding 22.

In the present modification, for example, the normal conducting squirrel-cage winding may be constituted of a plurality of rotor bars using a normal conducting material and a pair of annular end rings that respectively short-circuit both ends of each rotor bar using the normal conducting material. For the plurality of rotor bars using a normal conducting material, a highly conductive material such as copper, aluminum, silver, or gold can be used. In a similar manner, the end ring using a normal conducting material may be constituted of a highly conductive material such as copper, aluminum, silver, or gold. Each end of each rotor bar that uses a normal conducting material and that protrudes from a slot is joined to each of the pair of end rings that uses a normal conducting material.

In the present modification, for example, when the superconducting rotor 20 is in a non-superconducting state, the superconducting rotating machine 100 can be mainly driven due to induced (sliding) rotation by the normal conducting squirrel-cage winding. Therefore, the superconducting winding 22 can be promptly placed in the magnetic flux flow state even during drive by, for example, mainly driving the superconducting rotor 20 by an induced torque during the non-superconducting state and applying a pulse voltage once the superconducting rotor 20 changes to a superconducting state due to cooling. Accordingly, even when the superconducting rotor 20 is mainly driven by an induced torque during the non-superconducting state, a transition to the synchronous rotation mode can be promptly made after the superconducting rotor 20 changes to a superconducting state.

In addition, in the present modification, a control circuit can be configured to determine whether or not the superconducting winding 22 is in a superconducting state (whether or not the superconducting rotating machine 100 is mainly caused to rotate by a synchronous torque) by monitoring a primary current signal, which is a signal of a primary current flowing through the stator winding 16 from the superconducting rotating machine 100. For example, a configuration can be adopted in which when the rotor is mainly caused to rotate by a synchronous torque, the control pattern for synchronous rotation is applied to the superconducting rotating machine 100, but otherwise the control pattern for sliding rotation is applied on the assumption that the rotor is mainly caused to rotate by an induced (sliding) torque. Note that the normal conducting winding may be a plurality of members with a spliceless loop shape besides the squirrel-cage winding described above. A normal conducting winding with a spliceless loop shape may have a similar structure to the superconducting winding according to the present embodiment and may be arranged on the rotor in a similar arrangement.

### (Third Modification)

For example, while only a superconducting wire rod is used in the stator winding 16 of the stator 10 in the example described above, the present invention is not limited to this aspect. For example, the stator 10 may have another winding (normal conducting winding) using a normal conducting wire rod besides the stator winding 16 or may use a normal conducting wire rod instead of the superconducting wire rod. In this case, for example, the superconducting rotating machine 100 can be configured to form a magnetic pole with a normal conducting winding in the stator 10 so that a rotating magnetic field can be generated even in a normal conducting state. According to this configuration, for example, the superconducting rotating machine 100 can be started and driven even before the superconducting wire rod of the stator winding 16 enters a superconducting state.

### (Other Modifications)

For example, the superconducting wire rod (superconducting wire rod material) described above is not limited to an yttrium-based high-temperature superconducting wire rod or the like and a metal-based low-temperature superconducting wire rod as typified by NbTi and Nb₃Sn, a bismuth-based high-temperature superconducting wire rod, or a magnesium diboride superconducting wire rod can be used.

In addition, while a case where wire rods are used as a superconducting material and a normal conducting material has been described in the present embodiment described above, the present invention is not limited to this aspect and, for example, bulk materials may be used as a superconducting material and a normal conducting material. For example, bulk materials may be used as a superconducting material and/or a normal conducting material in accordance with an application (for example, a large superconducting motor) in which a material with a large current capacity is desirably used in a stator or a rotor.

Furthermore, while an aspect in which a contact region of each spliceless loop member 26 is electrically separated instead of being actively electrically insulated has been described in the present embodiment presented above, the present invention is not limited to this aspect. For example, the superconducting rotating machine according to the present embodiment may be configured so that spliceless loop members coated by an insulator film are used to electrically separate the contact region of each spliceless loop member. In this case, the insulator film may coat an entire surface of each spliceless loop member or the insulator film may only be provided in the contact region of each spliceless loop.

While various embodiments of the present invention have been described, it is to be understood that the present invention is not limited to the embodiment described above. In addition, various modifications may be made to the present invention without departing from the spirit or scope of the invention.

The entire disclosure of Japanese Patent Application No. 2021-147281, filed on Sep. 10, 2021, is incorporated in the present specification by reference.

In addition, all documents, patent applications, and technical standards described in the present specification are incorporated herein by reference to the same extent and with the same force and effect as if each document, patent application, and technical standard was specifically and individually described to be incorporated herein by reference.

### REFERENCE SIGNS LIST

10 stator
12 stator iron core
16 stator winding
20 superconducting rotor
22 superconducting winding
26 spliceless loop member
100 superconducting rotating machine

1. A superconducting rotating machine, comprising:
a stator that has a tubular stator iron core and a stator winding wound around the stator iron core, and that generates a rotating magnetic field; and
a superconducting rotor that is rotatably held by the rotating magnetic field of the stator and that has a superconducting winding including a plurality of coil-shaped spliceless loop members made of a superconducting material, and a rotor iron core including a slot for housing the spliceless loop members.

2. The superconducting rotating machine according to claim 1, wherein the superconducting winding includes a plurality of electrically separated spliceless loop members.

3. The superconducting rotating machine according to claim 1, wherein the spliceless loop members are sheet-like members having a notched part.

4. The superconducting rotating machine according to claim 1, wherein the spliceless loop members are housed in the slot so as come into contact with at least a part of another one of the spliceless loop members.

5. A ship including the superconducting rotating machine according to claim 1.

6. An automobile including the superconducting rotating machine according to claim 1.

7. An aircraft including the superconducting rotating machine according to claim 1.

8. A pump including the superconducting rotating machine according to claim 1.
